(19) United States
(12) Patent Application Publication
(10) Pub. No.: US 2003/0018647 A1
(43) Pub. Date: Jan. 23, 2003

(54) System and method for data compression using a hybrid coding scheme

(76) Inventor: Jan Bialkowski, San Jose, CA (US)

Correspondence Address: CARR & FERRELL LLP, 2225 EAST BAYSHORE ROAD, SUITE 200, PALO ALTO, CA, 94303, US

(21) Appl. No.: 10/188,120

(22) Filed: Jul. 1, 2002

Related U.S. Application Data
(60) Provisional application No. 60/301,926, filed on Jun. 29, 2001.

(51) Int. Cl. G06F 17/00; G06F 7/00

(52) U.S. Cl. 707/101

(57) ABSTRACT

A system and method for data compression using a hybrid coding scheme includes a dictionary, a statistical model, and an encoder. The dictionary is a list containing data patterns each associated with an index. The indices of received data patterns are sent to the statistical model and to the encoder. The statistical model gathers statistical information for the indices and sends it to the encoder. The encoder uses the statistical information to encode the indices from the dictionary. The encoder is preferably an arithmetic encoder.

### CROSS REFERENCE TO RELATED APPLICATIONS

The present application claims the benefit of priority from U.S. Provisional Patent Application No. 60/301,926, entitled “System and Method for Data Compression Using a Hybrid Coding Scheme” filed on Jun. 29, 2001, which is incorporated by reference herein.

### BACKGROUND OF THE INVENTION

1. Field of the Invention

This invention relates generally to lossless data compression and relates more particularly to data compression using a hybrid coding scheme.

2. Description of the Background Art

Current data switching devices are known to operate at bit rates in the hundreds of gigabits/sec (Gbit/sec). However, conventional servers rely on data storage in disk drives and are currently limited to serving data at rates in ranges of tens of Megabits/sec (Mbit/sec). Thus the switching capacity of devices in a communications network has far outstripped the ability of server machines to deliver data. As such, disk drives have become a limiting factor in increasing overall network bit rates. Therefore, platforms capable of delivering increased amounts of bandwidth are needed.

Dynamic random access memory may alternatively be used in place of disk drives. However, such memory is approximately three orders of magnitude more expensive than disk drives and heretofore has not been utilized in conventional server machines. A system designer is in such case faced with a choice of either using existing lossless compression techniques that are not effective in compressing data to the extent necessary to make use of dynamic random access memory economical or using lossy compression algorithms that reduce data fidelity and ultimate users' experience.

In addition to pressures exerted by network switch performance, advanced applications require bit rates far in excess of current server capabilities. For example, one of the formats defined for High Definition Television (HDTV) broadcasting within the United States specifies 1920 pixels horizontally by 1080 lines vertically, at 30 frames per second. Given this specification, together with 8 bits for each of the three primary colors per pixel, the total data rate required is approximately 1.5 Gbit/sec. Because of the 6 MHz channel bandwidth allocated, each channel will only support a data rate of 19.2 Mbit/sec, which is further reduced to 18 Mbit/sec by the need for audio, transport and ancillary data decoding information support within the channel. This data rate restriction requires that the original signal be compressed by a factor of approximately 83:1. Due to limitations of hardware systems, transmission and storage of large amounts of data increasingly rely on data compression. Data compression typically depends on the presence of repeating patterns in data files. Patterns in the data are typically represented by codes requiring a fewer number of bits.

One traditional type of data compression system uses a dictionary. Data patterns are catalogued in a dictionary and a code or index of the pattern within the dictionary having fewer bits than the pattern itself is used to represent the data (See e.g., Ziv, “IEEE Transactions on Information Theory”, IT 23-3, pp. 337-343, May, 1977; Welch, U.S. Pat. No. 4,558,302.). Looking up the code in the dictionary decompresses the data. This type of compression system typically requires that the decompression system have a copy of the dictionary, which sometimes may be transmitted with the compressed data but typically is reconstructed from the compressed data stream.

Another traditional type of data compression system is based on usage frequency to encode data patterns most efficiently (See e.g., Huffman, “Proceedings of the Ire”, September 1952, pp. 1098-1101; Pasco “Source Coding Algorithms for Fast Data Compression” Doctoral Thesis, Stanford Univ., May 1976.). The data file is analyzed to determine frequency information about the data in the file that is then used to encode the data so that frequently occurring patterns are encoded using fewer bits than less frequently occurring patterns. Context-sensitive statistical models gather statistical information about data patterns that appear in one or more contexts. As more contexts are included in the model, the encoding of data becomes more effective; however the model itself becomes large and complex requiring storing large number of frequency counters.

Implementing some data compression systems may require large amounts of resources such as memory and bandwidth. Thus, there is a need for a data compression system capable of efficiently compressing large data files.

### SUMMARY OF THE INVENTION

The invention is a data compressor that uses a hybrid coding scheme. The hybrid coding scheme is a combination of a dictionary coding method and a statistical, or entropy, encoding method. The data compressor of the invention includes a dictionary that catalogues data patterns, a statistical model that tracks frequency of use of the data patterns in the dictionary, and an entropy-based encoder.

The dictionary looks up each received pattern. If the pattern is present, the index of that pattern is sent to the statistical model and the encoder. If the pattern is not present, the dictionary assigns a next available index to the pattern, and then sends the index to the statistical model and the encoder.

The statistical model includes a context-sensitive array of counters. The counters accumulate statistical data about the indices representing data patterns in the dictionary, specifically frequency of the occurrence of the specific data patterns. The statistical model sends this information to the encoder. The encoder is preferably an arithmetic encoder that uses the statistical information from the statistical model to encode the indices received from the dictionary. In addition, the statistical model detects more complex patterns in the received data and sends these patterns to the dictionary where they are assigned new indices that are subsequently sent to the statistical model. This way the content of the dictionary evolves to include frequently occurring concatenations of shorter data patterns.

In practical implementations the dictionary is bounded in size, so for large data files the dictionary may become full before the entire file has been processed. Thus, the dictionary may be cleaned up by deleting entries having a low frequency of occurrence. The dictionary uses a set of predetermined rules to determine which entries will be replaced. Such rules associate each dictionary entry with a metric that numerically expresses anticipated usefulness of carrying the entry. For instance, such a metric may be the frequency of use, or the frequency multiplied by length of the pattern. The entry having the lowest metric value, or a set of entries having a metric value below a certain, either statically or dynamically determined, threshold value, is eligible for deletion.

### BRIEF DESCRIPTION OF THE DRAWINGS

FIG. 1 is a block diagram of one embodiment of a data processing system, including a data compressor, according to the invention;

FIG. 2 is a block diagram of one embodiment of the data compressor of FIG. 1 according to the invention;

FIG. 3 is a diagram of one embodiment of the dictionary of FIG. 2 according to the invention;

FIG. 4 is a diagram of one embodiment of the statistical model of FIG. 2 according to the invention;

FIG. 5 is a flowchart of method steps for data compression according to one embodiment of the invention; and

FIG. 6 is a flowchart of method steps for updating the dictionary of FIG. 2 according to one embodiment of the invention.

### DETAILED DESCRIPTION OF THE INVENTION

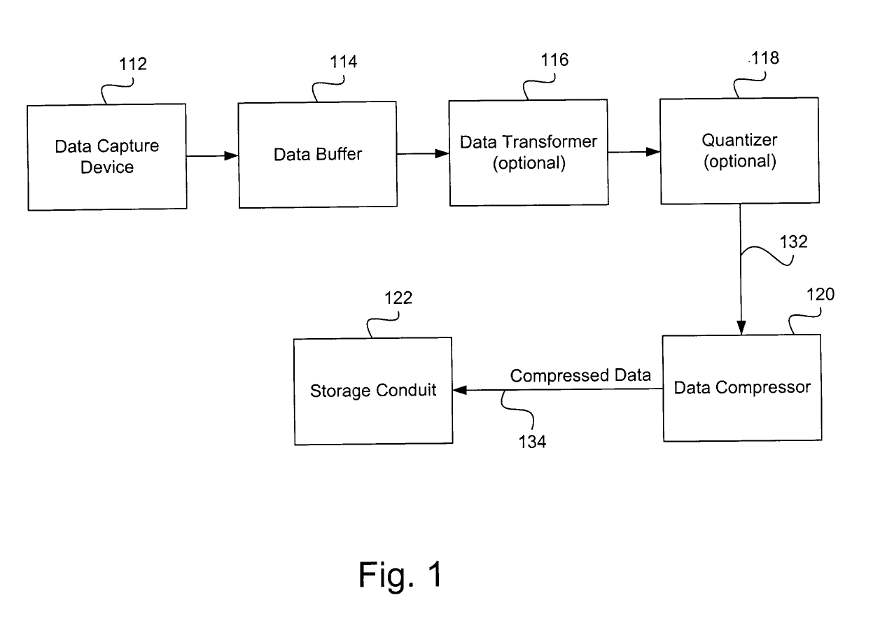

FIG. 1 is a block diagram of one embodiment of data processing system 100 that includes, but is not limited to, a data capture device 112, a data buffer 114, an optional data transformer 116, an optional quantizer 118, a data compressor 120, and a storage conduit 122 for storage or transmission of data. Data processing system 100 may be configured to process any type of data, including but not limited to, text, audio, still video, and moving video.

Data capture device 112 captures data to be processed by system 100. Data capture device 112 may be a keyboard to capture text data, a microphone to capture audio data, or a digital camera to capture video data as well as other known data capture devices. The captured data is stored in data buffer 114. Data transformer 116 may apply a transform function to the data stored in data buffer 114. For example, data transformer 116 may perform a Fourier transform on audio data, or a color-space transform or a discrete cosine transform (DCT) on video data. Quantizer 118 may quantize the data using any appropriate quantization technique.

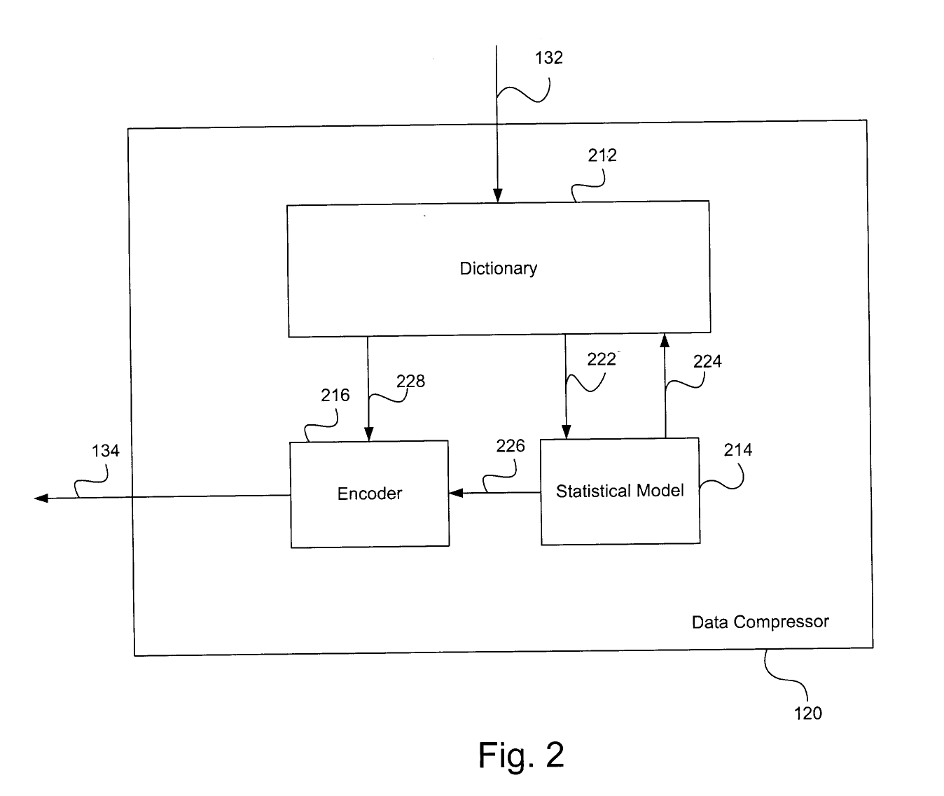

If the data has been transformed and quantized, data compressor 120 receives data as separate files, data packets, or messages via path 132. Data compressor 120 compresses the data before sending it via path 134 to storage conduit 122. The contents and functionality of data compressor 120 are discussed below in conjunction with FIG. 2. Storage conduit 122 may be any type of storage media, for example a magnetic storage disk or a dynamic random access memory (DRAM). Instead of storing the compressed data, system 100 may transmit the compressed data via any appropriate transmission medium to another system.

FIG. 2 is a block diagram of one embodiment of the data compressor 120 of FIG. 1, which includes, but is not limited to, a dictionary 212, a statistical model 214, and an encoder 216. Data received via path 132 is input to dictionary 212. Dictionary 212 is an adaptive dictionary that clears all entries for each file (packet, message) newly received by data compressor 120. Thus, each file is compressed independently of any other files received by data compressor 120.

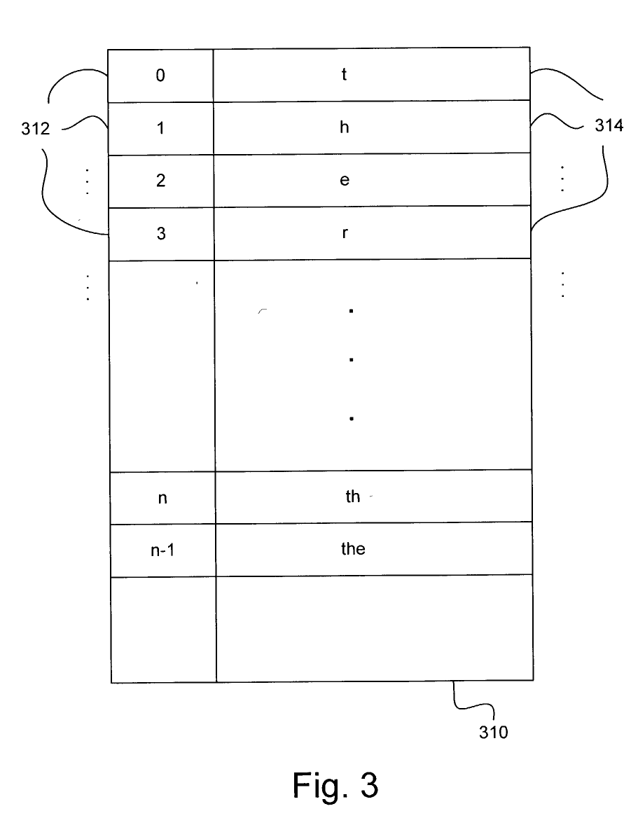

Each data file received by data compressor 120 comprises discrete units of data. For text files each unit may be a character, and for video files each unit may be a pixel. Adjacent data units may be grouped together as a pattern; for example a text pattern may be a word or words, and a video pattern may be a set of pixels. For purposes of discussion, a pattern may contain one or more data units. Dictionary 212 stores one or more received patterns in a list, where each of the one or more patterns is associated with an index. The structure of dictionary 212 is further discussed below in conjunction with FIG. 3.

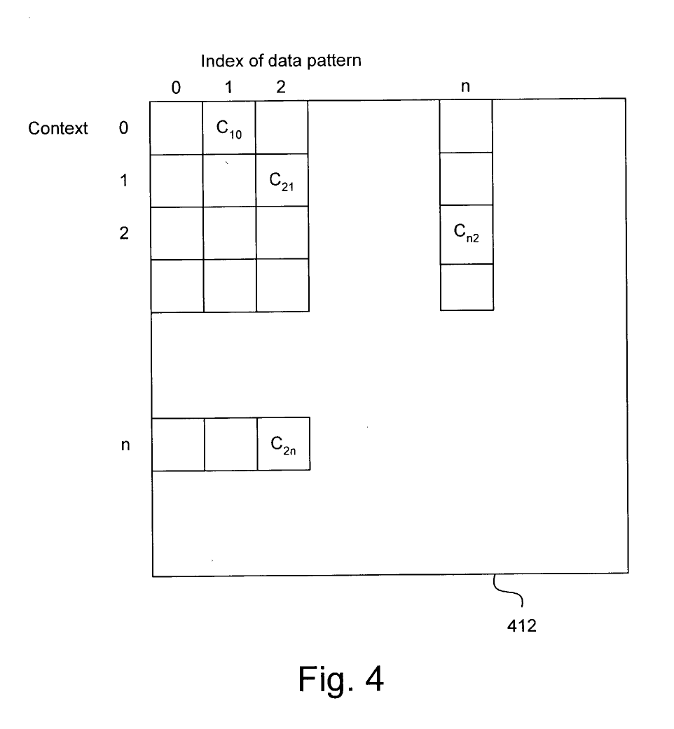

For each received pattern, dictionary 212 determines the index for that pattern. If the pattern is not present, dictionary 212 adds the pattern and assigns it an index. Dictionary 212 outputs the index for each received pattern via path 222 to statistical model 214 and via path 228 to encoder 216. Statistical model 214 is a context-sensitive model that measures the frequency of occurrence of patterns, represented by indices, in the data. The context, which may be empty in a simplest embodiment, consists of previously seen data pattern indices. Statistical model 214 is further described below in conjunction with FIG. 4. Statistical model 214 sends, via path 226, statistical information about the indices to encoder 216.

Statistical model 214 sends information via path 224 to update dictionary 212. When statistical model 214 identifies a pattern's index or a context-pattern index pair with a frequency of occurrence that is greater than a predetermined threshold, that pattern is sent to dictionary 212 where it is assigned a new index.

Encoder 216 is preferably an arithmetic encoder; however, other types of entropy-based encoders, such as a Huffman encoder, are within the scope of the invention. Encoder 216 uses the statistical information from statistical model 214 to encode the indices received from dictionary 212. Encoder 216 typically uses fewer bits to represent indices with a high frequency of occurrence and uses greater numbers of bits to represent indices with a lower frequency of occurrence. Encoder 216 outputs coded, compressed data via path 134 to storage conduit 122. Statistical encoding is further described in “The Data Compression Book,” by Mark Nelson and Jean-Loup Gailly (M&T Books, 1996), which is hereby incorporated by reference.

FIG. 3 is a diagram of one embodiment 310 of dictionary 212 as a one-dimensional array. Other, more efficient, implementations of dictionary 212 are also possible since dictionary 212 is searched frequently. For instance, a tree based search, or a hash table may be used. Dictionary 310 may contain any practical number of indices 312 and corresponding data locations 314; however, the number of indices is bounded. In the FIG. 3 embodiment 310, the dictionary contains patterns of text data. Text data will be described here, although dictionary 212 may contain any type of data. Each text pattern received by dictionary 310 is stored in a location 314 that corresponds to an index 312. Although numerical indices are shown in FIG. 3, any type of symbol may be used as indices 312.

If system 100 is processing a text file, the first word of the received text file may be “the.” The first pattern “t” is received by dictionary 310 and stored in the location corresponding to index 0. The next pattern “h” is stored in dictionary 310 and assigned index 1. As each index is assigned, that index is sent to statistical model 214 and encoder 216. As each “t” in the text file is received by dictionary 310, index 0 is sent to statistical model 214 and encoder 216.

In the received text file, the pattern “h” in the context of “t” occurs often enough that statistical model 214 recognizes the high frequency of occurrence and updates dictionary 310 with the pattern “th.” The new pattern “th” is assigned the next available index, n. Statistical model 214 may also determine that the pattern “e” in the context of “th” occurs often in the text file, and updates dictionary 310 with the pattern “the.” Dictionary 310 assigns the pattern “the” an index n+1, and sends the index to statistical model 214 and encoder 216.

FIG. 4 is a diagram representing one embodiment of statistical model 214. The FIG. 4 embodiment illustrates the set of frequency counters as a 2-dimensional array 412 allowing for one context index (row number) and one current pattern index (column number); however, statistical model 214 may gather statistical information using any number of contexts. The set of statistical counters may also be implemented in ways other than an array, such as a tree, a list, or hash table. Each column of array 412 represents an index of dictionary 212 and each row represents a context. The context of an index is the index that immediately preceded it in the received data. As shown above in FIG. 3, an “h” following a “t” in the text will be considered to have a context of “t.”

Statistical model 214 resets all counters, columns, and rows of array 412 for each new data file processed by system 100. In the notation of FIG. 4, a counter “C”'s first subscript is the column or index number, and the second subscript is the row or context number. If the first word of a text file received by system 100 is “the,” the first pattern is “t,” assigned index 0 by dictionary 212. Thus, statistical model 214 assigns index 0 to a column and a row in array 412. The next received pattern is “h,” assigned index 1. Statistical model 214 assigns index 1 to a column and a row in array 412. Also, since index 1 was received after index 0, statistical model 214 increments the counter C₁₀ representing “index 1 in the context of index 0.”

The next pattern received is “e,” assigned index 2. Statistical model 214 assigns a row and a column to index 2, and increments the counter C₂₁ that corresponds to “index 2 in the context of index 1.” If the counter C₁₀ reaches a value that is greater than a threshold, then statistical model 214 sends the pattern “th” for storage to dictionary 212. The pattern “th” is assigned an index n that is then added to array 412. In this manner, statistical model 214 accumulates statistical information about the data file input to system 100.

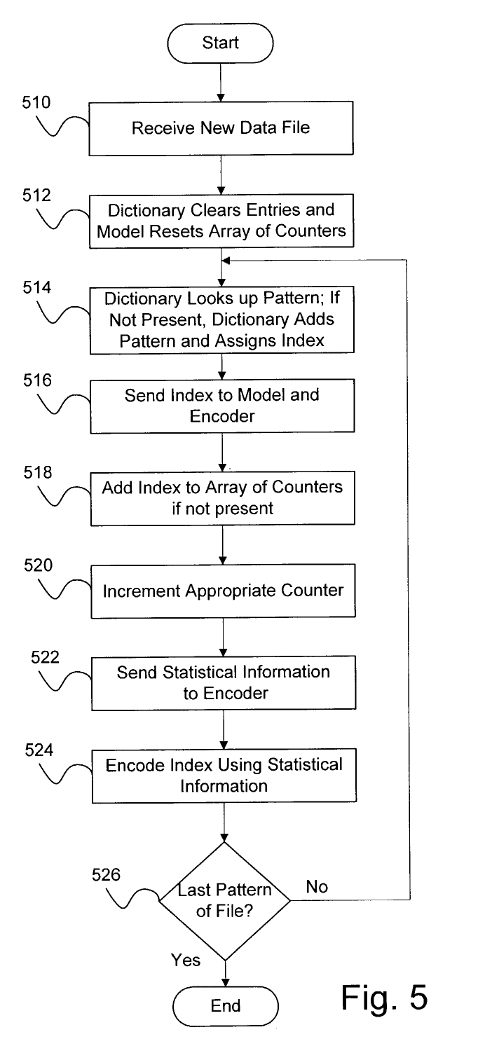

FIG. 5 is a flowchart of method steps for compressing data, according to one embodiment of the invention. First, in step 510, system 100 receives a new data file for compression. In step 512, dictionary 212 clears all indices 312 and data locations 314, and statistical model 214 resets all counters, columns, and rows of array 412. Then, in step 514, dictionary 212 looks up the first pattern. Since the first pattern will not yet be present, dictionary 212 adds the first pattern and assigns it an index.

In step 516, dictionary 212 sends the index of the pattern to statistical model 214 and to encoder 216. The first few patterns of the file will be encoded without statistical information from statistical model 214. In step 518, the index is added to the array of counters in statistical model 214. In the 2-dimensional embodiment shown in FIG. 4, the index is added as a column and a row. Then, in step 520, statistical model 214 increments the appropriate counter. Statistical model 214 then sends statistical information, including the value of the counter corresponding to the current index from dictionary 212, to encoder 216.

In step 524, encoder 216 uses the statistical information from statistical model 214 to encode the index. A special case of a newly added pattern with a new index has to be considered so that the receiver will be able to recreate the dictionary. For this case either the new pattern is sent unencoded or, preferably, the statistical model has a special “escape” model that is used in such a case. Encoder 216 preferably implements arithmetic encoding. Then, in step 526, data compressor 120 determines whether the current pattern is the last pattern of the file. If the pattern is the last of the file, the FIG. 5 method ends. If the pattern is not the last in the file, the FIG. 5 method returns to step 514, where dictionary 212 looks up the next pattern.

The method steps of FIG. 5 may be similarly applied to a decoding process. A decoder must rebuild the dictionary and statistical information using the encoded data. For each compressed data file received, a decoder dictionary and a decoder statistical model are cleared, and then supplied with information during the decoding process.

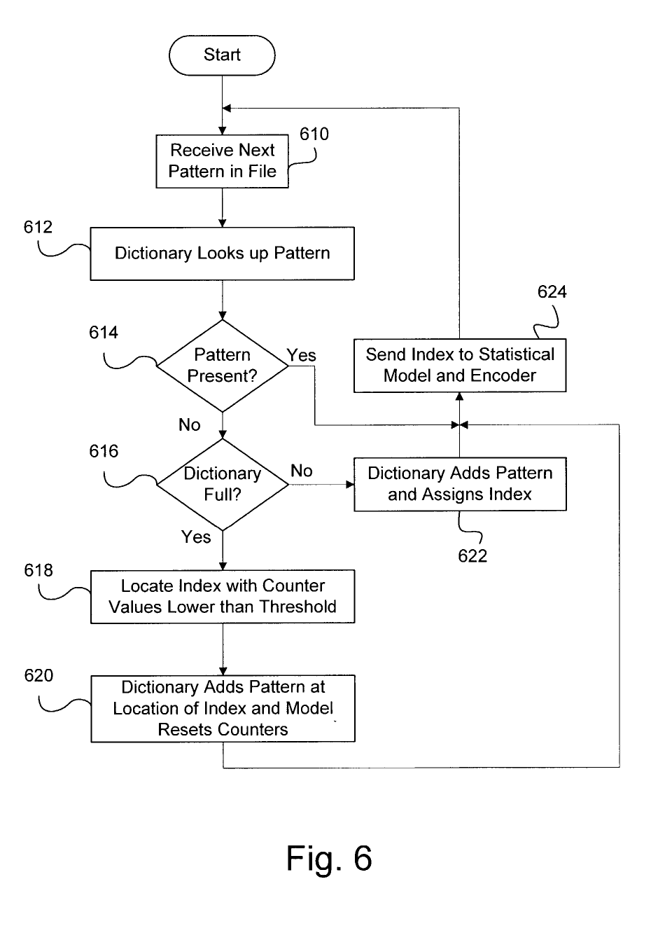

FIG. 6 is a flowchart of method steps for updating dictionary 212 (FIG. 2), according to one embodiment of the invention. Dictionary 212 may be configured to store a large number of patterns but it is bounded. For large data files, dictionary 212 may become full before the entire file has been processed. Thus, data compressor 120 is preferably configured to update dictionary 212.

First, in step 610, dictionary 212 receives the next pattern in the file. Then, in step 612, dictionary 212 looks up the current pattern. In step 614, dictionary 212 determines whether the current pattern is present. If the pattern is present, then in step 624, the index of the pattern is sent to statistical model 214 and to encoder 216. Then the method returns to step 610, where dictionary 212 receives the next pattern in the data file.

If the current pattern is not present in the dictionary, then in step 616 dictionary 212 determines whether it is full. If dictionary 212 is not full, then in step 622 dictionary 212 adds the pattern and assigns the pattern an index. The FIG. 6 method then continues with step 624.

If in step 616 dictionary 212 is full, then in step 618 statistical model 214 locates an index in array 412 with counter values lower than a threshold. An index with low counter values has a low probability of occurrence, so the pattern represented by that index may be replaced with the new, previously unknown, pattern. A user of system 100 preferably predetermines the threshold. Other rules for determining an entry of dictionary 212 that may be replaced are within the scope of the invention.

Then, in step 620, dictionary 212 adds the pattern at the location of the identified index and statistical model 214 resets the corresponding counters in array 412. The FIG. 6 method then continues with step 624.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method for data compression comprising the steps of:
receiving a data file having data patterns;
storing received data patterns in a dictionary;
assigning an index to each data pattern in the dictionary;
storing the index of each data pattern in the dictionary;
accumulating statistical information about each index;
encoding each index using the statistical information; and
clearing stored indices and stored data patterns in the dictionary when another data file is received.

2. The method of claim 1, wherein the step of accumulating statistical information is performed by a statistical model.

3. The method of claim 2, wherein each index is encoded by an encoder.

4. The method of claim 3, wherein if the received data pattern does not match any of the stored data patterns in the dictionary, and if the dictionary is not full, then the dictionary sends the index assigned to the received data pattern to the encoder and the statistical model.

5. The method of claim 3, wherein if the received data pattern does not match any of the stored data patterns in the dictionary, and if the dictionary is full, then the statistical model instructs the dictionary to replace a stored data pattern with the received data pattern, and the dictionary sends the index associated with the stored data pattern to the encoder and the statistical model.

6. The method of claim 3, wherein if the received data pattern matches the stored data pattern in the dictionary, then the dictionary sends the index associated with the stored data pattern to the encoder and the statistical model.

7. The method of claim 2, wherein the step of accumulating statistical information comprises the steps of:
receiving indices from the dictionary;
recording the frequency of occurrence of each index within a set of frequency counters; and
updating the dictionary.

8. The method of claim 7, wherein the statistical model resets the set of frequency counters when another data file is received.

9. The method of claim 7, wherein the set of frequency counters contains a distinct and unique counter for each distinct and unique pair of context indices and a current pattern index.

10. The method of claim 7, wherein the set of frequency counters contains a distinct and unique counter for each distinct and unique tuple of arbitary context indices and a current pattern index.

11. The method of claim 9, wherein a context index of the current pattern index is another index received just prior to the current pattern index.

12. The method of claim 10, wherein context indices of the current pattern index are other indices received just prior to the current pattern index.

13. The method of claim 11, wherein upon receiving index n after receiving context index m, where n and m are integers, a frequency counter associated with an element {m, n} is incremented.

14. The method of claim 12, wherein upon receiving index n after receiving context indices mₖ, mₖ₋₁, . . . , m₁, m₀, where n and mⱼ are integers, a frequency counter associated with an element {mₖ, . . . , m₀, n} is incremented.

15. The method of claim 13, wherein if the frequency counter exceeds a threshold value, then the statistical model sends index n and context index m to the dictionary.

16. The method of claim 14, wherein if the frequency counter exceeds a threshold value, then the statistical model sends index n and context indices mₖ, mₖ₋₁, . . . , m₁, m₀ to the dictionary.

17. The method of claim 15, wherein the dictionary stores a new data pattern associated with context index m and index n, and assigns the new data pattern a new index.

18. The method of claim 16, wherein the dictionary stores a new data pattern associated with context indices mₖ, mₖ₋₁, . . . , m₁, m₀ and index n, and assigns the new data pattern a new index.

19. The method of claim 3, wherein the encoder is an arithmetic encoder.

20. The method of claim 3, wherein the encoder is a Huffman encoder.

21. The method of claim 19, wherein the encoder receives statistical information from the statistical model and indices from the dictionary.

22. The method of claim 21, wherein the statistical information includes frequency of occurrence of each index.

23. The method of claim 22, wherein the encoder uses fewer bits to encode a first index with a higher frequency of occurrence than to encode a second index with a lower frequency of occurrence.

24. A system for data compression, comprising:
a data buffer for storing data;
a data compressor configured to compress data from the data buffer, comprising:
a dictionary configured to determine an index for one or more patterns;
a statistical model configured to measure the frequency of occurrence of the one or more patterns; and
an encoder configured to use statistical information from the statistical model to encode indices received from the dictionary.

25. The system of claim 24, further comprising:
a data transformer configured to apply a transform function to data in the data buffer; and
a quantizer configured to quantize the data in the data buffer.

26. The system of claim 24, wherein the dictionary includes a bounded number of indices and corresponding data locations.

27. The system of claim 26, wherein the dictionary is a one-dimensional array.

28. The system of claim 26, wherein the dictionary is tree based.

29. The system of claim 26, wherein the dictionary is a hash table.

30. The system of claim 24, wherein the statistical model is a two-dimensional array.

31. The system of claim 24, wherein the statistical model is a tree.

32. The system of claim 24, wherein the statistical model is a list.

33. The system of claim 24, wherein the statistical model is a hash table.

34. The system of claim 24, wherein the encoder is an arithmetic encoder.

35. The system of claim 24, wherein the encoder is a Huffman encoder.

36. A system for data compression, comprising:
a data compressor configured to compress data, comprising:
a dictionary configured to determine an index for one or more patterns;
a statistical model configured to measure the frequency of occurrence of the one or more patterns; and
an encoder configured to use statistical information from the statistical model to encode indices received from the dictionary.

37. The system of claim 36, wherein the dictionary includes a bounded number of indices and corresponding data locations.

38. The system of claim 37, wherein the dictionary is a one-dimensional array.

39. The system of claim 37, wherein the dictionary is tree based.

40. The system of claim 37, wherein the dictionary is a hash table.

41. The system of claim 36, wherein the statistical model is a two-dimensional array.

42. The system of claim 36, wherein the statistical model is a tree.

43. The system of claim 36, wherein the statistical model is a list.

44. The system of claim 36, wherein the statistical model is a hash table.

45. The system of claim 36, wherein the encoder is an arithmetic encoder.

46. The system of claim 36, wherein the encoder is a Huffman encoder.

47. A computer-readable medium storing instructions for causing a computer to compress data, by performing the steps of:
receiving a data file having data patterns;
storing received data patterns in a dictionary;
assigning an index to each data pattern in the dictionary;
storing the index of each data pattern in the dictionary;
accumulating statistical information about each index;
encoding each index using the statistical information; and
clearing stored indices and stored data patterns in the dictionary when another data file is received.

48. A system for data compressing, comprising:
means for receiving a data file having data patterns;
means for storing received data patterns in a dictionary;
means for assigning an index to each data pattern in the dictionary;
means for storing the index of each data pattern in the dictionary;
means for accumulating statistical information about each index;
means for encoding each index using the statistical information; and
means for clearing stored indices and stored data patterns in the dictionary when another data file is received.

49. A computer-readable medium storing instructions for causing a computer to compress data, by performing the steps of:
receiving a data file having data patterns;
storing received data patterns in a dictionary;
assigning an index to each data pattern in the dictionary;
storing the index of each data pattern in the dictionary;
accumulating statistical information about each index; and
encoding each index using the statistical information.

50. A system for data compressing, comprising:
means for receiving a data file having data patterns;
means for storing received data patterns in a dictionary;
means for assigning an index to each data pattern in the dictionary;
means for storing the index of each data pattern in the dictionary;
means for accumulating statistical information about each index; and
means for encoding each index using the statistical information.
